(19) United States
(12) Patent Application Publication
(10) Pub. No.: US 2026/0299204 A1
(43) Pub. Date: Oct. 1, 2026

(54) OPTICAL INTERCONNECT FOR HIGH PERFORMANCE COMPUTER ARCHITECTURE

(71) Applicant: International Business Machines Corporation, Armonk, NY (US)

(72) Inventors: Frank Robert Libsch, White Plains, NY (US); Arvind Kumar, Stamford, CT (US)

(21) Appl. No.: 19/095,860

(22) Filed: Mar. 31, 2025

(51) Int. Cl. G02B 6/26; G02B 6/32; G02B 6/42; G02B 6/43

(52) U.S. Cl. CPC G02B 6/262; G02B 6/32; G02B 6/4206; G02B 6/4214; G02B 6/43

(57) ABSTRACT

Optical system and devices facilitating bidirectional, non-crossing optical node communications for high-speed, high bandwidth communication system architectures. The system includes an array of bi-directional (or even tri- or quad-directional) optical signal/light turning elements, each light turning element including one or more turning mirrors that can be inserted into an optical PCBs. Each light turning element of the array includes: a set of waveguide structures, each waveguide structure of said set for receiving and channeling optical signals; a set of internal light reflective surfaces, each internal light reflective surface associated with each waveguide structure, and one or more light focusing lenses disposed above said set of internal light reflective surfaces, each internal light reflective surface receiving optical signals through one light focusing lens for re-direction to a waveguide structure, or receiving optical signals from a waveguide structure for re-direction through the one light focusing lens.

### FIELD OF THE DISCLOSURE

The present application relates to devices, systems and methods for communicating optical signals in high performance computing systems. More specifically, the present application is directed to opto-electronic devices for coupling optical signals to/from optical waveguides in optical networks provided in printed circuit boards and electronic semiconductor packages.

### BACKGROUND

As digital technology advances, the need for higher rates of data transfer in high performance computers and data centers increases. Such data transfers require technological solutions that allow for high channel density in compact forms.

Recently optical multi-chip modules that include an organic laminated build-up substrate and polymer wave-guide layers have been developed. In such modules, optoelectronic chip arrays, e.g., Vertical-cavity Surface Emitting Lasers (VCSELs) and photodiodes are mounted by flip-chip bonding near CPU chips, and micro-lenses used for light coupling into and out of waveguide cores.

While there is much literature on microlenses and some on mirrors, most lens arrays are for microdisplays or for optical fiber connectors. For VCSELs and PDs, the arrays are usually 1-D arrays matching the VCSEL footprint of 1×4, 1×8 or 1×12.

Alternative methods of forming turning mirrors in waveguides (WGs) rely on laser ablation, which is a serial low throughput process requiring many laser passes to reduce roughness, alignment inaccuracies, and restriction on the ultimate density/closeness to any adjacent mirrors. Moreover, prior art methods of fabricating a micro-mirror array for coupling in polymer waveguides are limited to 1D arrays and rectilinear arrangements. Such 1D array element use much more valuable host chip escape perimeter and is not scalable. This 1D array element does uni-direction (one way) optical coupling on a PCB. Existing light turning elements (i.e., mirrors) are uni-directional (one way) coupling. That is, for VCSELs and PDs (Photodiodes or Photodetectors), the arrays are usually 1-D arrays matching the VCSEL footprint of 1×4, 1×8 or 1×12.

### SUMMARY

In one aspect of the present disclosure, there is provided an optoelectronic device structure used to form multi-dimensional optoelectronic arrays providing for high bandwidth computing that require many parallel links.

The optoelectronic device structure includes two or more reflecting surfaces of a unitary pyramidal structure under one optical source/detector/chip integrated in a packaging substrate so that light from or to the optical source/detector/chip go to or be received from more than one direction from more than one other chips on the substrate.

The optoelectronic device is compatible with having the lens on the top optical element (OE) input/output path, on a side waveguide (WG) input/output path, or on a mirror.

In one aspect, the optoelectronic device element is extendable for optoelectronic systems implementing both 1D and 2D optical arrays.

In a further aspect, a single optoelectronic device element provides for bi-directional (or even tri-or quad-directional) turning mirrors that can be inserted into optical PCBs, for example, polymer WG PCBs.

In a further aspect, the optoelectronic device element is an embedded mirror array element based on totally internal reflection (TIR) that does not need a reflective metal coating.

In one aspect, plural optoelectronic device element can be configured in a staggered arrangement, e.g., a staggered 2D array element that uses the same host chip escape perimeter, and polymer wave guide (PCB) perimeter independent of the array depth. For example, a M×N optical I/O (from VCSELs or PDs) would take M times less chip and PCB perimeter than prior art 1D elements.

In a further aspect, the optoelectronic device element configurable as either a uni-directional or bi-directional in-plane WG coupling on a PCB.

Further, the optoelectronic device element is compatible with all (metal, dielectric, TIR) mirror technologies, including the less costly, lower loss TIR mirror.

The optoelectronic device element is configurable to provide an optical beam shaped by one or more methods, including top and/or side lens, mirror to lens distance, and waveguide clad/core material dimensions.

In a further aspect, a system provides an optoelectronic device element configurable as a staggered lens arrays with staggered mirror elements for use in higher density polymer WG PCBs that are invaluable for AI or high-performance computing applications.

In one aspect of the disclosure, there is provided an optical coupling element. The optical coupling element comprises: a set of waveguide structures, each waveguide structure of the set for receiving and channeling optical signals; a set of internal light reflective surfaces, each internal light reflective surface associated with each waveguide structure, one or more light focusing lenses disposed above the set of internal light reflective surfaces, each internal light reflective surface receiving optical signals through one light focusing lens for re-direction to a waveguide structure, or receiving optical signals from a waveguide structure for re-direction through the one light focusing lens.

In another aspect of the present disclosure, there is provided an optical communication system. The optical communication system comprises: an optical substrate; an array of optical coupling elements formed on the optical substrate, each optical coupling element of the array comprising: a set of waveguide structures, each waveguide structure of the set for receiving and channeling optical signals; a set of internal light reflective surfaces, each internal light reflective surface associated with each waveguide structure, one or more light focusing lenses disposed above the set of internal light reflective surfaces, each internal light reflective surface receiving optical signals through one light focusing lens for re-direction to a waveguide structure, or receiving optical signals from a waveguide structure for re-direction through the one light focusing lens; and an array of optical signal light signal generators disposed in alignment with the array of light turning elements formed on the optical substrate, each optical signal light generator sourcing an optical signal for receipt through a corresponding light focusing lens.

In yet another aspect of the present application there is provided an optical communication system. The optical communication system comprises: an optical substrate; an array of light turning elements formed on the optical substrate, each light turning element of the array comprising: a set of waveguide structures, each waveguide structure of the set for receiving and channeling optical signals; a set of internal light reflective surfaces, each internal light reflective surface associated with each waveguide structure, one or more light focusing lenses disposed above the set of internal light reflective surfaces, each internal light reflective surface receiving optical signals through one light focusing lens for re-direction to a waveguide structure, or receiving optical signals from a waveguide structure for re-direction through the one light focusing lens; and an array of optical signal light signal detectors disposed in alignment with the array of light turning elements formed on the optical substrate, each optical signal light detector sensing an optical signal received from a corresponding light focusing lens.

### BRIEF DESCRIPTION OF THE DRAWINGS

Further features as well as the structure and operation of various embodiments are described in detail below with reference to the accompanying drawings. In the drawings, like reference numbers indicate identical or functionally similar elements.

FIGS. 1A-1C depict various embodiments of a one-piece staggered in-plane bidirectional optical focusing turning element with unidirectional or bidirectional waveguiding;

FIGS. 2A-2E depict various embodiments of light turning elements according to embodiments of the invention;

FIG. 3A depicts respective top views of a VCSEL and PD array according to an embodiment;

FIG. 3B shows a cross-sectional view of an assembly consisting of a VCSEL array element overlayed on a respective in-plane bidirectional optical focusing turning element;

FIG. 3C shows an exposed view of a one piece staggered in-plane bidirectional optical focusing turning element according to an embodiment;

FIGS. 4A-4C illustrate components of an optical system including a further embodiment of a one piece staggered in-plane bidirectional optical focusing turning element with bidirectional waveguiding;

FIGS. 5A-5B depicts an embodiment of a 4-directional turning element of FIG. 2E replicating the two-dimensional (in-plane) turning elements in the 1×M staggered, turning element blocks that can be part of a lens array such as depicted in FIG. 4C;

FIGS. 6A-6C show a top view and two side views, respectively, of a staggered or angled arrangement of 2×N three dimension, four-directional light turning array that can be part of a lens array such as depicted in FIG. 4C;

FIG. 7 depicts a cross-sectional view of a single layer optical printed circuit board (PCB) providing waveguide routing enabled with optical lens focusing mirror array element according to embodiments herein;

FIG. 8 depicts a cross-sectional view of a two-layer optical-PCB providing waveguide routing enabling node-to-node architecture enabled with optical focusing lens turning mirror array element according to embodiments herein;

FIG. 9 depicts a cross-sectional view of an assembly including an optical PCB structure for use as a higher bandwidth (BW) on-board node-to-node architecture using the focusing lens turning mirror array according to embodiments herein;

FIG. 10 depicts a further multi-node architecture that forms a higher bandwidth node-to-node architecture enabled with non-crossing single layer optical interconnect elements integrated into the optical PCB according to embodiments herein;

FIG. 11 depicts a further multi-node architecture that forms a higher bandwidth node-to-node architecture enabled with a focusing lens turning mirror array integrated into the optical PCB according to embodiments herein; and

FIGS. 12A-12E depict various embodiments for routing optical signals in a high bandwidth on-board node-to-node architecture with focusing lens turning mirror array elements integrated into an optical PCB according to embodiments herein.

### DETAILED DESCRIPTION

According to an aspect of the present invention, there is provided an optical coupling element. The optical coupling element comprises: a set of waveguide structures, each waveguide structure of the set for receiving and channeling optical signals; a set of internal light reflective surfaces, each internal light reflective surface associated with each waveguide structure, one or more light focusing lenses disposed above the set of internal light reflective surfaces, each internal light reflective surface receiving optical signals through one light focusing lens for re-direction to a waveguide structure, or receiving optical signals from a waveguide structure for re-direction through the one light focusing lens. Incorporation of the optical coupling elements into high bandwidth optical communication systems enables for non-crossing waveguiding node-to-node communications to provide better signal integrity (less crosstalk).

The optical coupling element has an internal pyramidal structure having n sides, where n≥1, each side having an internal light reflective surface formed thereon. The set of waveguide structures comprise n waveguide structures, each waveguide structure in alignment with a respective internal light reflective surface for channeling light to and from a corresponding internal light reflective surface. Thus, the optical coupling element enables bi-directionality (or even tri-and quad-directionality) allow 2×, 3×, or 4× waveguide density increase per printed circuit board layer thereby enabling a higher bandwidth architecture as well as lower cost due to fewer layers that would normally be needed to avoid waveguide crossing.

The optical element further uses a single light focusing lens located at a surface of the optical element, each of the n internal light reflective surfaces reflecting optical signals to the single lens. This enables more compactness and can work for a broad range of light wavelengths.

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

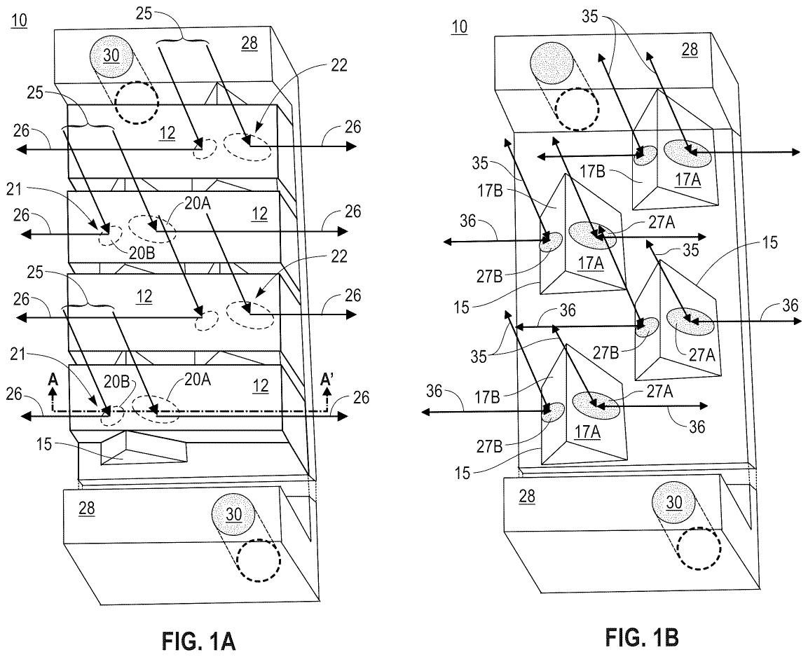

FIG. 1A illustrates an exemplary one-piece staggered in-plane bi-directional optical focusing turning element with unidirectional waveguiding.

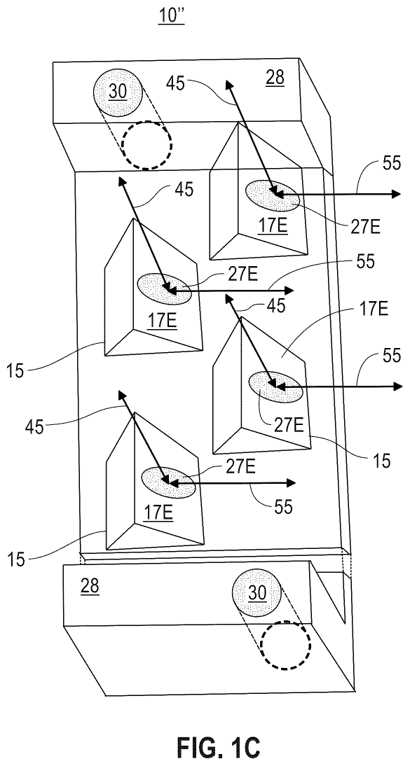

In FIG. 1A, there is depicted a top view of a one piece staggered in-plane bi-directional optical focusing turning element with unidirectional waveguiding shown as an array 10 of light turning elements 12. In view of FIG. 2A, each light turning element 12 is in the form of a block or substrate having a triangular or pyramidal structure or portion 15 either removed or embedded therein. In the embodiment shown in FIG. 1B, for ease of illustration, the top surface of each light turning element 12 of FIG. 1A is removed to reveal facet 15 of the triangular or pyramidal portion having the reflecting mirror 15 in FIG. 1B.

FIG. 2A is a cross-sectional view taken along line A-A′ of FIG. 1A depicting an embodiment of the light turning element or block 12. The light turning block 12 includes a block of molded glass, plastic or silicon providing a triangular or pyramidal portion 15 (shown removed). At the triangular or pyramidal portion 15, on one side edge or facet is a reflective surface such as provided by a total internal reflecting mirror 17A formed on the inner edge of the turning element block. On the other side edge or facet is a further reflective surface such as provided by a further total internal reflecting mirror 17B. These mirrors 17A, 17B may be dielectric (TIR) or reflective metal coated to reflect optical signals such as shown as approximate locations 27A, 27B of reflected optical signals in FIG. 1B. As shown in FIG. 2A, elements 16A and 16B are waveguides representing the light channeling horizontally in the turning element or block 12 to the respective edges of block 12. One implementation is for waveguides that are aligned to the light channeling at the edges of block 12, thereby providing a continuous channeling horizontally of light from block 12 to the waveguide. Another implementation formed internal to the turning element block 12 on one side of the block there is a first waveguide 16A laterally oriented and extending from a block edge to abut the one side edge or facet 15A of the triangular or pyramidal portion having the totally internal reflecting mirror 17A formed thereon. Similarly, on the other side of the turning element block is a second waveguide 16B laterally oriented and extending from a block edge to abut another side edge or facet 15B of the triangular or pyramidal portion (shown removed) and having the totally internal reflecting mirror 17B formed thereon. Above each respective side edge or facet 15A, 15B, and formed on top of the block 12, is a respective top collimating/focusing lens 20A, 20B. These focusing lens' are aligned with each side edge or facet 15A, 15B of block 12 and in alignment with each reflective mirror surface 17A, 17B. In one embodiment, each collimating/focusing lens 20A, 20B can receive light or optical signals 25 sourced from above the block 12 and focus light or optical signals into the block via a respective optic channel or waveguide 18A, 18B for impingement upon a respective TIR mirror 17A, 17B where any received optical signal is reflected for transmission within a respective waveguide 16A, 16B for communication outside the block 12. Similarly, each waveguide 16A, 16B can receive light or optical signals that are sourced from devices outside of the block 12 and focus the received light or optical signals onto a respective TIR mirror 17A, 17B where any received optical signal is reflected vertically for transmission within a respective waveguide 18A,18B for communication outside the block 12. Each of the waveguides 16A, 16B in the turning element block 12 couple light or optic signals from the outside of the block to their respective internal reflecting surfaces, e.g., at TIR mirrors 17A, 17B, in order to change direction of the optical signals and reflect the received signals to another direction. The depiction of waveguides 16A, 16B, 18A and 18B represent the light or received optical signal that is channeled in block 12 by either the material (i.e., glass, polymer, plastic or silicon) of block 12 or an embedded waveguiding clad and core material within block 12.

FIG. 2B shows another embodiment of a light turning element 13 in the form of a block or substrate having a pyramidal portion 15 (e.g., either removed or embedded therein) and having facets including light signal reflecting elements in a staggered orientation. The use of pyramidal structure with different facets including light signal reflecting elements enables more compactness and can work for a broad range of light wavelengths.

In the cross-sectional view shown in FIG. 2B and depicting a further embodiment of a light turning element 13 which corresponds to the light turning element 12 of FIG. 2A there is included a staggered orientation of light collimating/focusing lens 20C, 20D and turning or light reflective mirrors 17C, 17D. For example, in FIG. 2B, the light turning element block 13 includes a block of molded glass, plastic or silicon having a triangular or pyramidal portion 15, however, at the inner surface of the block at the pyramidal portion 15, on one inner side edge or facet 15C is a reflective surface such as provided by a total internal reflecting mirror 17C formed on the inner edge of the turning element block. On the other side edge or facet 15D is a further reflective surface such as provided by a total internal reflecting mirror 17D that is further set back deeper towards an edge of the block opposite edge having mirror 17C. The mirrors 17C, 17D may be dielectric, TIR or reflective metal coated to reflect optical signals. As shown in FIG. 2B, formed internal to the turning element block 13 on one side of the block there a waveguide 16D laterally oriented and extending from a block edge to the one side edge 15D of the removed triangular or pyramidal portion having the totally internal reflecting mirror 17D set back therein. Similarly, on the other side of the turning element block is the second waveguide 16C laterally oriented and extending from a block edge to another side edge 15C of the triangular or pyramidal portion and having the totally internal reflecting mirror 17C formed thereon. Above each respective side edge 15C, 15D, and formed on top of the block 13, is a respective top collimating/focusing lens 20C, 20D. These focusing lens' 20C, 20D are in a staggered orientation aligned with each side edge 15° C., 15D of block 13 and in alignment with each respective reflective mirror surface 17C, 17D. In one embodiment, each focusing lens 20C, 20D can receive light or optical signals sourced from above the block 13 and focus light or optical signals into the block via a respective optic channel or waveguide 18C, 18D for impingement upon a respective TIR mirror 17C, 17D where any received optical signal is reflected for transmission within a respective waveguide 16C, 16D for communication outside the block 13. Similarly, each waveguide 16C, 16D can receive light or optical signals that are sourced from devices outside of the block 13 and focus the received light or optical signals onto a respective TIR mirror 17C, 17D where any received optical signal is reflected vertically for transmission within a respective waveguide 18C, 18D for communication outside the block 13. Each of the waveguides 16C, 16D in the turning element block 13 couple light or optic signals from the outside of the block to their respective internal reflecting surfaces, e.g., at TIR mirrors 17C, 17D, in order to change direction of the optical signals and reflect the received signals to another direction. The depiction of waveguides 16C, 16D, 18C and 18D represent the light or received optical signal that is channeled in block 13 by either the material (i.e., glass, polymer, plastic or silicon) of block 13 or an embedded waveguiding clad and core material within block 13.

Referring back to FIG. 1A, the lens array 10 includes an arrangement of light turning element blocks 12 with turning mirrors as shown in FIG. 2A, with each light turning element block created by etching or molding glass, silicon or plastics substrates. The mirrors may be dielectric (TIR) or reflective metal coated. In an embodiment, the lens array may contain anti-reflection coatings to improve coupling efficiency. The lens array 10 may be located at the top-most surface (shown), on the mirror surface, or on a waveguide (WG) plane, dependent on the focal point distance of the lens array 10. In other embodiments, the lens array 10 may be of ellipsoidal or paraboloidal protrusions, focusing or collimating. As shown in FIG. 1A, light signals 25 such as generated from a VCSEL vertical-cavity surface-emitting laser is received at top most lenses, e.g., lens groups 21, 22, etc. and are reflected by the TIR mirror surfaces and outputting the optic signals as light signals 26 emanating from the in-plane optical waveguide core index at each side of each light turning element block 12.

In FIG. 1A the alternating block elements 12, the arrangement of focusing lenses are staggered, i.e., each adjacent block 12 includes the optical focusing turning elements and top lying focusing lenses as lens “groups” at opposite sides of the block as shown as lens group 21 on a first block and lens group 22 situated on an opposite side of an adjacent second block. Further, as shown in FIG. 1A, at each end of the array 10 is connected a further block 28 that includes an alignment hole 30 which is used to accurately place the array in a precise position on a substrate, interposer, printed circuit board (PCB), or like carrier structure.

FIG. 1B shows the array of light turning elements shown in FIG. 1A, that omits the top focusing lens for clarity and exposes light reflective surfaces of the pyramidal portion 15 of the light turning block 12. While there is a 2×2 array of mirrors, the array can be an M×N array of mirrors. However, as shown in FIG. 1B, the optical signals are shown as bi-directional signals 35 that either are received at each light turning element block 12 at the top focusing lenses (not shown) that are internally reflected by turning mirror or reflective surfaces 17A, 17B (focusing lens image) and exit laterally shown at approximate locations 27A, 27B as reflected optic signals 36 from the block elements via waveguide cores (not shown). Alternately, as shown in FIG. 1B, the optical signals are shown as bi-directional signals 36 that either are received via the side horizontally oriented waveguide cores at each light turning element block 12 that are internally reflected by turning mirror or reflective surfaces 17A, 17B and exit laterally as optic signals 35 at the top focusing lenses (not shown) of the block elements 12 via vertical waveguide cores (not shown).

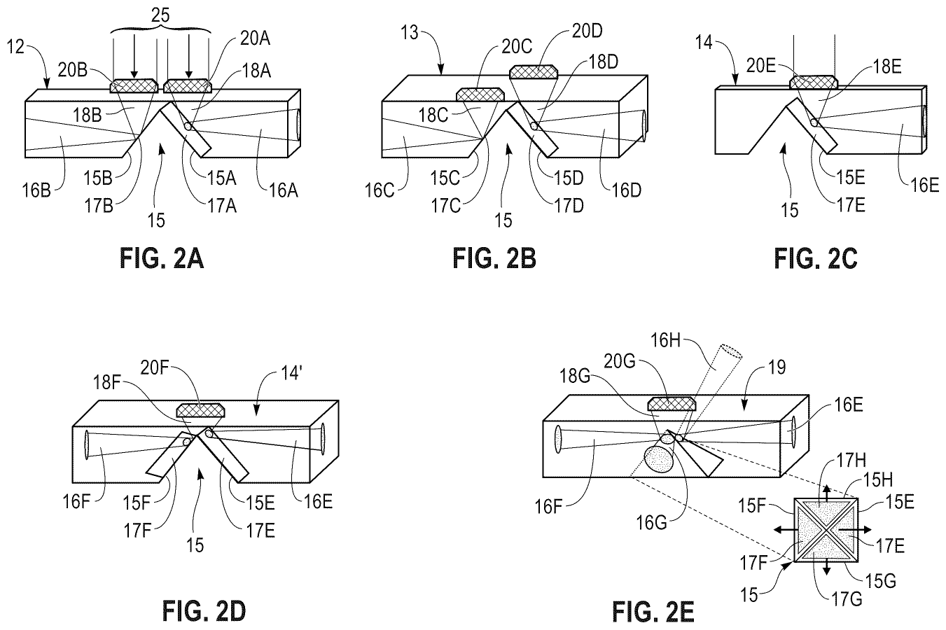

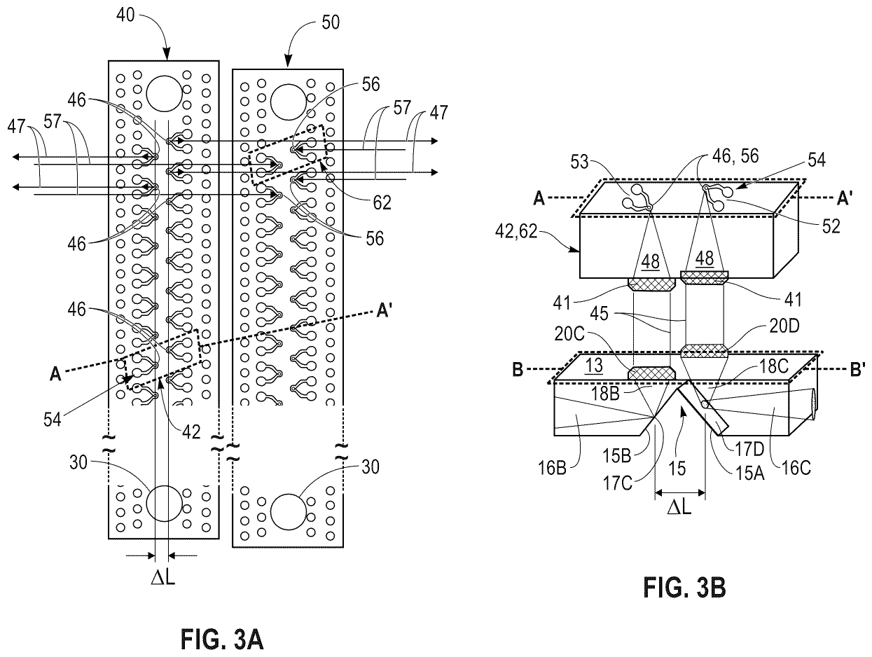

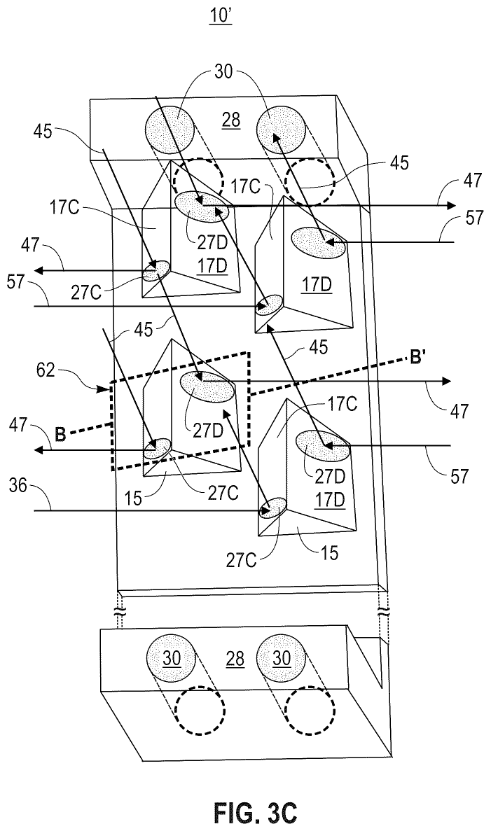

FIGS. 3A-3C illustrate components of an optical system including an exemplary one-piece staggered in-plane bi-directional optical focusing turning element with bi-directional waveguiding.

In particular, there is depicted in FIG. 3A a top view of a VCSEL array 40 or alternatively, a top view of a photodetector (PD) array 50. In FIG. 3A, the VCEL array 40 depicted is a 2×N array of a staggered arrangement of light emitting devices, e.g., VCSELS, in a staggered arrangement that correspond with a respective arrangement of the focusing lens on top of underlying light turning element, e.g., either light turning element block 12 of FIG. 2A or light turning element block 13 of FIG. 2B. That is, taking the VCEL array 40 of 2×N VCSELs, FIG. 3B shows a cross-sectional view of the overlay of an optical emission area or optical emission portion 42 of the VCSEL array 40 taken along line A-A′ shown in FIG. 3A over a light turning element block 13 showing a staggered arrangement of top collimating/focusing lens. In a non-limiting embodiment, at VCSEL array 40 consists of multiple VCSEL element unit blocks 42 depicted in the staggered linear arrangement along one or more rows. As shown in FIG. 3B, each of these VCSEL element unit blocks 42 organized into a VCSEL array 40 consist of two optical signal sources, e.g., VCSEL/optical elements 46, provided at a VCSEL array unit block 42 located at two optical emission areas 52, 53 in a staggered orientation. In each VCSEL array unit block 42, the optical elements 46 are separated by at least a distance AL which corresponds to a distance AL shown separating the two TIR surfaces or mirrors 17C, 17D shown in the turning element block 13. Connecting each respective VCSEL light emitting source at optical emission areas 52, 53 are a pair of optical element electrical pads 54 for receiving signals used to actuate the VCSEL light source at VCSEL Array 40 to provide light signals for input to the light turning element block 13 shown disposed underneath with two sets of collimating/focusing lenses in direct alignment. The VCSEL Array unit block 42 further includes two optical signal paths 48 at each respective VCSEL element 46 for focusing optic signals into a respective collimating/focusing lens 41 shown in a corresponding staggered orientation at a bottom surface of the VCSEL Array unit block 42. In FIG. 3A, element 48 represents the light or optical signal that is channeled in block 42 by either the material (i.e., glass, polymer, plastic or silicon) of block 42 or an embedded waveguiding clad and core material within block 42. Each respective collimating/focusing lens 41 focusses optical signals 45 into the aligned top collimating/focusing lens 20C, 20D at the top surface of turning element block 13 shown in FIG. 3B. FIG. 3A conceptually depicts two adjacent VCSEL Array unit block 42 of VCSEL Array 40 with each VCSEL element 46 sourcing light or optic signals into turning block 13 that reflects them as optical signals 47 for transmission in waveguides (not shown) outside of linear turning block 13.

FIG. 3C depicts a further embodiment of the underlying lens array 10′ corresponding to the lens array 10 of FIG. 1B that includes an arrangement, e.g., 2×2 array, of light turning element blocks 13 with pyramidal portions (shown exposed) with turning mirrors or inner reflecting surfaces 17C, 17D providing approximate locations 27C, 27D for reflecting optical signals in a staggered orientation as shown in FIG. 3B. That is, FIG. 3B shows a cross-sectional view of the further disposed light turning element 13 taken along line B-B′ shown in the underlying lens array 10′ of FIG. 3C showing a staggered arrangement for providing reflected optical signals at approximate locations 27C, 27D via internal light reflective surfaces or TIR mirrors 17C, 17D. While there is a 2×2 array of mirrors shown, the array of FIG. 3C can be an M×N array of mirrors. In FIG. 3C, the top collimating/focusing lenses of each tuning element block 13 are not shown for clarity. In the embodiment of FIG. 3C, the arrangement of the reflecting surfaces or TIR mirrors 17C, 17D in light turning element blocks provided for one row underlying the array 40 depict the reception of optical signals 45 such as generated from a respective overlying VCSEL (not shown) at top most lenses that are reflected by TIR mirrors or reflecting surfaces 17C, 17D for transmission or conveyance through turning element block 13 as optic signals 47 reflected at approximate staggered locations 27C, 27D through laterally extending waveguides (not shown).

Returning to and in further view of FIG. 3A there is depicted a similarly structured photodetector array 50 depicted is a 2×N array of staggered photodiode or like photodetector device elements 62 that can be in alignment with a respective arrangement of the collimating/focusing lens on top of the light turning element, e.g., either light turning element block 12 of FIG. 2A or light turning element block 13 of FIGS. 2B, 3B of the optical 2-D planar or staggered arrays. In a non-limiting embodiment, as shown in FIG. 3B, the photodetector device elements 62 are structured similarly to the VCSEL element unit blocks 42, however, instead include a photodetector element 56 to receive optical signals transmitted through the light turning element block. A photodetector element 56 can be a photodiode or like light receiving device. As in the VCSEL array 40, photodetector array 50 of FIG. 3A include photodetector element unit blocks 62 depicted in the staggered linear arrangement along one or more rows. As further shown in FIG. 3B, each of these photodetector element unit blocks 62 organized into a photodetector array 50 consist of two optical signal sensors, e.g., photodetector elements 56, provided at a photodetector array unit block 62 located at two optical emission areas 52, 53 in a staggered orientation. In each photodetector array unit block 62, the photodetector elements 56 are also separated by at least a distance AL which corresponds to a distance separating the two TIR surfaces or mirrors 17C, 17D shown in the turning element block 13. Connecting each respective photodetector 56 at optical emission areas 52, 53 are a pair of optical element electrical pads 54 for receiving signals used to actuate the photodetector at photodetector array 50 to receive light signals from the light turning element block 13 shown disposed underneath with two sets of collimating/focusing lenses in direct alignment. The photodetector array unit block 62 further includes two optical signal paths 48 at each respective photodetector element 56 for receiving optic signals from a respective collimating/focusing lens 41 shown in a corresponding staggered orientation at a bottom surface of the photodetector array unit block 62. Element 48 represents the light or optical signal that is channeled in block 62 by either the material (i.e., glass, polymer, plastic or silicon) of block 62 or an embedded waveguiding clad and core material within block 62. Each respective collimating/focusing lens 41 focusses received optical signals 45 from the aligned top collimating/focusing lens 20C, 20D at the top surface of turning element block 13 shown in FIG. 3B. FIG. 3A conceptually depicts two adjacent photodetector array unit blocks 62 of photodetector array 50 with each photodetector element 56 receiving light or optic signals 57 from waveguides (not shown) outside of linear light turning block 13 that reflects the optical signals for detection at a photodetector element 56.

Returning to FIG. 3C, there is depicted a further embodiment of the underlying lens array 10′ corresponding to the lens array 10 of FIG. 1B that includes an arrangement, e.g., 2×2 array, of light turning element blocks 13 with pyramidal portions (shown exposed) with turning mirrors or inner reflecting surfaces 17C, 17D providing approximate locations 27C, 27D for reflecting optical signals in a staggered orientation as shown in FIG. 3B. In FIG. 3C, the top collimating/focusing lenses of each tuning element block 13 are not shown for clarity. In the embodiment of FIG. 3C, the arrangement of the reflecting surfaces or TIR mirrors 17C, 17D in light turning element blocks provided for one row underlying the array 50 depict the reception of optical signals 57 from laterally extending waveguides (not shown) at the outside of light turning element block 13 and reflecting them at approximate staggered locations 27C, 27D by TIR mirrors or reflecting surfaces 17C, 17D as signals 45 to be received at a respective overlying photodetector element (not shown).

FIG. 2C is a cross-sectional view depicting a further embodiment of a light turning element 14 in the form of a block or substrate having a pyramidal portion 15 either removed or embedded therein and which corresponds to the light turning element 12 of FIG. 2A however, including only a single light collimating/focusing lens 20E and a single turning or light reflective mirror 17E. For example, in FIG. 2C, the light turning element block 14 includes a block of molded glass, plastic or silicon having a triangular or pyramidal portion 15, however, at the inner surface of the block above the removed portion, on one inner side edge or facet 15E is a reflective surface such as provided by a total internal reflecting mirror 17E formed on the inner edge of the turning element block. The mirror 17E may be dielectric, TIR or reflective metal coated to reflect optical signals. As shown in FIG. 2C, formed internal to the turning element block 14 on one side of the block there is an optical signal path 16E laterally oriented and extending from a block edge to the one side edge or facet 15E of the triangular or pyramidal portion having the totally internal reflecting mirror 17E thereon. Above side edge or facet 15E and formed on top of the block 14, is a respective top collimating/focusing lens 20E. The focusing lens 20E is in alignment with reflective mirror surface 17E. In one embodiment, focusing lens 20E can receive light or optical signals sourced externally from above the block 14 and focus light or optical signals into the block via a respective optical signal path 18E for impingement upon TIR mirror 17E where any received optical signal is re-directed for transmission within optical signal path 16E for communication outside the block 14. Similarly, optical signal path 16E can receive light or optical signals that are sourced from devices outside of the block 14 and focus the received light or optical signals onto a respective TIR mirror 17E where any received optical signal is re-directed vertically for transmission within optical signal path 18E for communication outside the block 14. The optical signal path 16E in the turning element block 14 couple light or optic signals from the outside of the block to internal reflecting surface, e.g., at TIR mirror 17E, in order to change direction of the optical signals and reflect the received signals to another direction. Elements 16E, 18E represent the light or optical signal that is channeled in block 14 by either the material (i.e., glass, polymer, plastic or silicon) of block 14 or an embedded waveguiding clad and core material within block 14.

FIG. 1C shows a top view of a one piece staggered in-plane uni-directional Optical Focusing Turning element with unidirectional waveguiding according to an embodiment and particularly an embodiment of an array 10″ of light turning elements such as shown in FIG. 1A, that omits the top focusing lens for clarity and exposes light reflective surfaces of the pyramidal portion of the light turning block 14 of FIG. 2C. While there is a 2×2 array of mirrors, the array can be an M×N array of mirrors. However, as shown in FIG. 1C, the optical signals are shown as uni-directional signals 45 that either are received at each light turning element block 14 at a single top focusing lens (not shown) that are internally reflected at approximate staggered locations 27E by turning mirror or reflective surface 17E (focusing lens image) and exit laterally as reflected optic signals 55 from the block elements via optical signal paths or waveguide cores (not shown). Alternately, in the array of FIG. 1C, the optical signals can be uni-directional signals 55 that can be received via the side horizontally oriented waveguide cores at each light turning element block 14 that are internally reflected by turning mirror or reflective surfaces 17E and exit laterally as optic signals 45 at the top focusing lenses (not shown) of the block elements 14 via vertical optical signal paths or waveguide cores (not shown).

FIG. 2D is a cross-sectional view depicting a further embodiment of a light turning element 14′ which corresponds to the light turning element 14 of FIG. 2C however, includes an additional waveguide channel 16F and corresponding aligned light reflective mirror 17F for re-directing received optical signals to the single lens 20F. For example, in FIG. 2D, the light turning element block 14′ includes a block of molded glass, plastic or silicon having a triangular or pyramidal portion 15, however, at the inner surfaces of the block above the removed portion, on one inner side edge or facet 15E is a reflective surface such as provided by a total internal reflecting mirror 17E formed on the inner edge of the turning element block. On the other side edge or facet 15F is a further reflective surface such as provided by a total internal reflecting mirror 17F that is opposite the edge having mirror 17E. The mirrors 17E, 17F may be dielectric, TIR or reflective metal coated to reflect optical signals. As shown in FIG. 2D, formed internal to the turning element block 14′ on one side of the block there is formed optical signal path 16E laterally oriented and extending from a block edge to abut the one side edge or facet 15E of the triangular or pyramidal portion 15 having the totally internal reflecting mirror 17E. Similarly, on the other side of the turning element block 14′ is a second optical signal path 16F laterally oriented and extending from a block edge to abut another side edge or facet 15F of the triangular or pyramidal portion and having the totally internal reflecting mirror 17F formed thereon. Above a peak of the pyramidal portion 15 and formed on top of the block 14′, is single a top collimating/focusing lens 20F. The focusing lens 20F is in alignment with each side edge 15E, 15F of block 14′ and in alignment with each respective reflective mirror surface 17E, 17F. In one embodiment, the single focusing lens 20F can receive light or optical signals sourced from above the block 14′ and focus light or optical signals into the block via an aligned optic channel or optical signal path 18F for impingement upon a respective TIR mirror 17E, 17F where any received optical signal is reflected for transmission within a respective optical signal path 16E, 16F for communication outside the block 14′. Similarly, each optical signal path 16E, 16F can receive light or optical signals that are sourced from devices outside of the block 14′ and focus the received light or optical signals onto a respective TIR mirror 17E, 17F where any received optical signal is reflected vertically for transmission within single optical signal path 18F for communication external to the block 14′. Each of the optical signal paths 16E, 16F in the turning element block 14′ couple light or optic signals from the outside of the block to their respective internal reflecting surfaces, e.g., at TIR mirrors 17E, 17F, in order to change direction of the optical signals and reflect the received signals to another direction. Elements 16E, 16F, 18F represents the light or optical signal that is channeled in block 14′ by either the material (i.e., glass, polymer, plastic or silicon) of block 14′ or an embedded waveguiding clad and core material within block 14′.

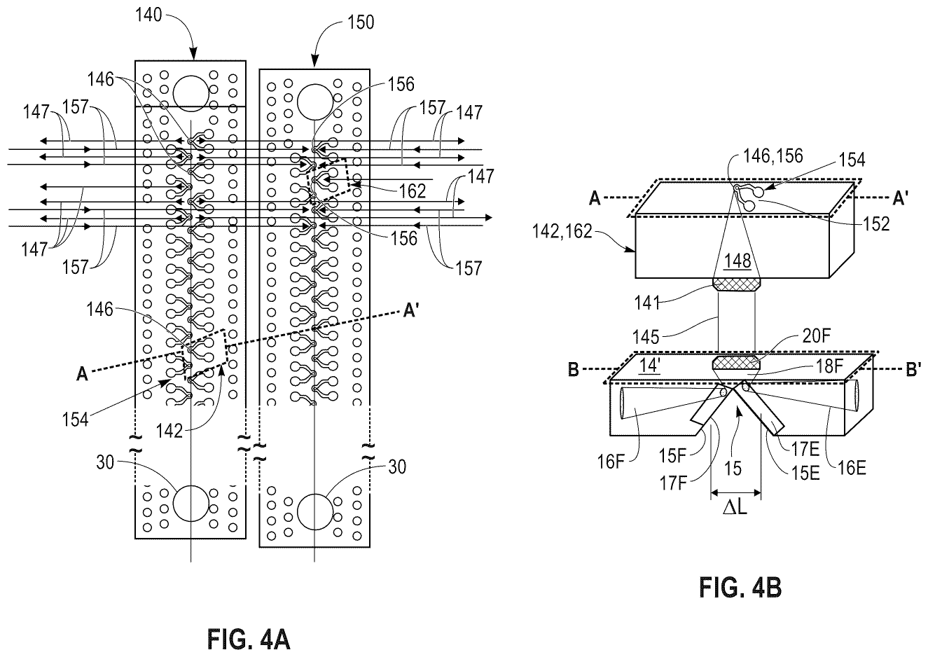

FIGS. 4A-4C illustrate components of an optical system including a further embodiment of a one Piece Staggered In-plane Bidirectional Optical Focusing Turning Element with Bidirectional Waveguiding.

In particular, there is depicted in FIG. 4A a top view of a VCSEL 1×N array chip 140 or alternatively, a top view of a photodetector (PD) 1×N array chip 150. Optionally, the VCSEL array chip or PD array chip can be combined to form a combined VCSEL and PD array chip. In FIG. 4A, the VCEL array 140 depicted is a 1×N array of an optically emitting in-line arrangement of light emitting devices, e.g., VCSELS, that correspond with a respective in-line arrangement of the focusing lens on top of underlying light turning element, e.g., light turning element block 14 of FIG. 2C or light turning element block 14′ of FIG. 2D. That is, taking the VCEL array 140 of 1×N VCSELs, FIG. 4B shows a cross-sectional view of the overlay of an optical emission area or optical emission portion 142 of the VCSEL array 140 taken along line A-A′ shown in FIG. 4A over a light turning element block 14′ showing a single top collimating/focusing lens. In a non-limiting embodiment, VCSEL array 140 consists of multiple VCSEL element unit blocks 142 depicted in an in-line or linear arrangement, e.g., along a single row. As shown in FIG. 4B, each of these VCSEL element light turning blocks 142 organized into a VCSEL array 140 consist of an optical signal source, e.g., VCSEL/optical element 146, provided at a VCSEL array unit block 142 located at an optical emission area 152 in an in-line orientation. In each VCSEL array unit block 142, the optical element 146 provides optical signals or light spanning at least a distance AL which corresponds to a distance AL shown separating the two TIR surfaces or mirrors 17E, 17F shown in the turning element block 14′. In embodiments, this distance may span 10 microns to 100 microns, e.g., after collimating.

Connecting a VCSEL light emitting source at optical emission area 152 is a pair of optical element electrical pads 154 for receiving signals used to actuate the VCSEL light source at VCSEL Array 140 to provide light signals for input to the light turning element block 14′ shown disposed underneath with a single collimating/focusing lens in direct alignment. The VCSEL Array unit block 142 further includes an optical waveguide structure 148 at the VCSEL element 146 for focusing optic signals into a single collimating/focusing lens 141 shown in an aligned orientation at a bottom surface of the VCSEL Array unit block 142. The collimating/focusing lens 141 focusses optical signals 145 into the aligned top collimating/focusing lens 20F at the top surface of turning element block 14′ shown in FIG. 4B. FIG. 4A conceptually depicts two adjacent VCSEL Array unit blocks 142 of VCSEL Array 140 in an in-line arrangement with each respective adjacent VCSEL element 146 sourcing light or optic signals into a respective turning block 14′ that reflects them at approximate in-line locations 27E, 27F as reflected optical signals 147 emanating from two side edges of light turning block 14′ for transmission in waveguides and fibers (not shown) outside of linear turning block 14′.

FIG. 4C depicts a further embodiment of the underlying lens array 10′″ corresponding to the lens array 10′ of FIG. 1B that includes an arrangement, e.g., 2×2 array, of light turning element blocks 14′ with pyramidal portions (shown exposed) with turning mirrors or inner reflecting surfaces 17E, 17F as shown in FIG. 4B. That is, FIG. 4B shows a cross-sectional view of the further disposed light turning element 14′ taken along line B-B′ shown in the underlying lens array 10″′ of FIG. 4C showing a staggered arrangement of internal light reflective surfaces or TIR mirrors 17E, 17F. While there is a 2×2 array of mirrors shown, the array 10′″ of FIG. 4C can be an M×N array of mirrors. In FIG. 4C, the top collimating/focusing lens of each tuning element block 14′ is not shown for clarity. In the embodiment of FIG. 4C, the arrangement of the reflecting surfaces or TIR mirrors 17E, 17F in light turning element blocks provided for one row underlying the array 140 depict the reception of optical signals 145 such as generated from a respective overlying VCSEL (not shown) at top most lenses that are reflected by TIR mirrors or reflecting surfaces 17E, 17F at approximate staggered locations 27E, 27F for transmission or conveyance through turning element block 14′ as reflected optic signals 147 through laterally extending optical signal paths or waveguides (not shown).

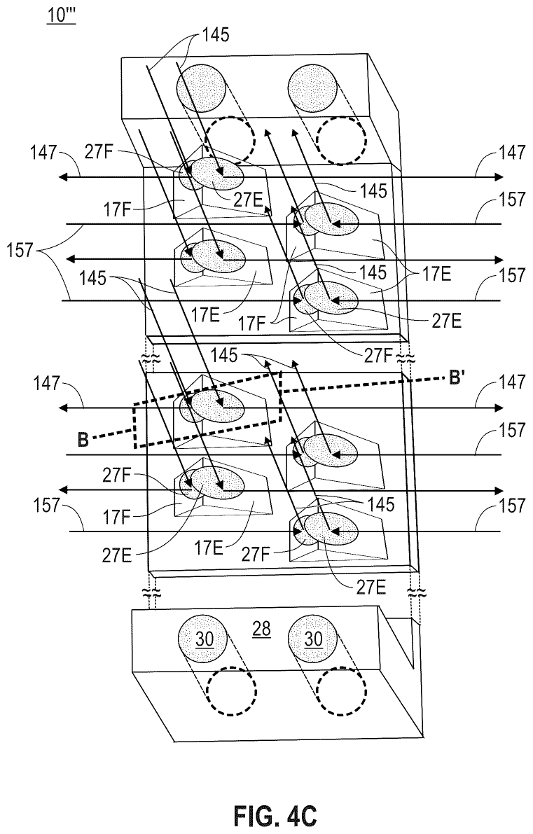

Returning to and in further view of FIG. 4A there is depicted a similarly structured photodetector array 150 depicted as a 1×N array of in-line photodiode or like photodetector device elements 162 that can be in alignment with a respective arrangement of the collimating/focusing lens on top of the light turning element, e.g., either light turning element block 14 of FIG. 2C or light turning element block 14′ of FIGS. 2D, 5B of the optical 2-D planar or staggered arrays. In a non-limiting embodiment, as shown in FIG. 4B, the photodetector device elements 162 are structured similarly to the VCSEL element unit blocks 142, however, instead include a photodetector element 156 to receive optical signals transmitted through the light turning element block. A photodetector element 156 can be a photodiode or like light receiving device. As in the VCSEL array 140, photodetector array 150 of FIG. 4A include photodetector element unit blocks 162 depicted in the staggered linear arrangement along one or more rows. As further shown in FIG. 4B, each of these photodetector element unit blocks 162 organized into a photodetector array 150 consist of a single optical signal sensor, e.g., photodetector element 156, provided at a photodetector array unit block 162 located at a single optical emission area 152. In each photodetector array unit block 162, the photodetector element 156 is dimensioned to receive optical signals in a span of a distance AL which corresponds to a distance separating the two TIR surfaces or mirrors 17E, 17F shown in the turning element block 14′. Connecting each respective photodetector 156 at an optical emission area 152 is a pair of optical element electrical pads 154 for receiving signals used to actuate the photodetector at photodetector array 150 to receive light signals from the light turning element block 14′ shown disposed underneath with a single collimating/focusing lens in direct alignment. The photodetector array unit block 162 further includes a single optical waveguide structure 148 corresponding to the photodetector element 156 for receiving optic signals from a respective collimating/focusing lens 141 shown in an aligned orientation at a bottom surface of the photodetector array unit block 162. The collimating/focusing lens 141 focusses received optical signals 145 from the aligned top collimating/focusing lens 20F at the top surface of turning element block 14′ shown in FIG. 4B. FIG. 4A conceptually depicts two adjacent photodetector array unit blocks 162 of photodetector array 50 with each photodetector element 156 receiving light or optic signals 157 from waveguides (not shown) outside of linear light turning block 14′ that reflects the optical signals for detection at a respective photodetector element 156.

Returning to FIG. 4C, there is depicted a further embodiment of the underlying lens array 10″ corresponding to the lens array 10 of FIG. 1B that includes an arrangement, e.g., 2×2 array, of light turning element blocks 14′ with pyramidal portions (shown exposed) with turning mirrors or inner reflecting surfaces 17E, 17F in an aligned orientation as shown in FIG. 4B. In FIG. 4C, the top collimating/focusing lens of each tuning element block 14′ is not shown for clarity. In the embodiment of FIG. 4C, the arrangement of the reflecting surfaces or TIR mirrors 17E, 17F in light turning element blocks provided for one row underlying the array 150 depict the reception of optical signals 157 from laterally extending optical signal paths or waveguides (not shown) at the outside of light turning element block 14 and reflecting them by TIR mirrors or reflecting surfaces 17E, 17F at approximate in-line locations 27E, 27F as reflected signals 145 to be received at a respective overlying photodetector element (not shown).

FIG. 2E is a cross-sectional view depicting a further embodiment of a 4-directional light turning element 19. This 4-directional light turning element 19 corresponds to the light turning elements 14, 14′ of FIGS. 2C, 2D, however, includes four optical signal paths 16E, 16F, 16G, 16H configured to receive optical signals at or output optical signals to corresponding four aligned light reflective mirrors. For example, in FIG. 2E, the light turning element block 19 includes a block of molded glass, plastic or silicon having a pyramidal portion 15 shown in a top view, as having corresponding four (4) light reflective surfaces 17E, 17F, 17G, 17H for re-directing received optical signals to the single lens 20G that provide unidirectional outgoing, unidirectional incoming or bidirectional light flow options. That is, at the inner surfaces of the block at a removed portion, on inner side edges or facets 15E, 15F, 15G, 15H is a reflective surface such as provided by respective total internal reflecting surfaces or mirrors 17E, 17F, 17G, 17H formed on the inner edges or facets of the turning element block. These four reflecting surfaces or mirrors 17E, 17F, 17G, 17H on each respective side edge 15E, 15F, 15G, 15H each face a respective side edge of four outer opposing side edges of light turning block 19. The mirrors 17E, 17F, 17G, 17H may be dielectric, TIR or reflective metal coated to reflect optical signals. As shown in FIG. 2E, each respective formed optical signal path 16E, 16F, 16G, 16H is laterally oriented and extend from a block side edge to abut the one side edge or facet of the triangular or pyramidal portion having the totally internal reflecting mirror. In the 4-directional light turning element 19 above a peak of the pyramidal portion 15 and formed on top of the block 19, is a single top collimating/focusing lens 20G. The focusing lens 20G is in alignment with each side edge or facet 15E, 15F, 15G, 15H of block 19 and in alignment with each respective reflective mirror surface 17E, 17F, 17G, 17H. In one embodiment, the single focusing lens 20G can receive light or optical signals sourced from above the block 19 and focus light or optical signals into the block via an aligned optic channel or optical signal path 18G for impingement upon a respective TIR mirror 17E, 17F, 17G, 17H where any received optical signal is reflected for transmission within a respective optical signal path 16E, 16F, 16G, 16H for communication outside the block 19. Similarly, each optical signal path 16E, 16F, 16G, 16H can receive light or optical signals that are sourced from devices outside of the block 19 and focus the received light or optical signals onto a respective TIR mirror 17E, 17F, 17G, 17H where any received optical signal is reflected vertically for transmission within single optical signal path 18G for communication external to the block 19. Each of the optical signal path 16E, 16F, 16G, 16H in the turning element block 19 couple light or optic signals from the outside of the block to their respective internal reflecting surfaces, e.g., at TIR mirrors 17E, 17F, 17G, 17H in order to change direction of the optical signals and reflect the received signals to another direction.

Elements 16E, 16F, 16G, 16H, 18G represent the light or optical signal that is channeled in block 19 by either the material (i.e., glass, polymer, plastic or silicon) of block 19 or an embedded waveguiding clad and core material within block 19.

As shown in FIGS. 5A-5B, in an embodiment, the 4-directional turning element 19 of FIG. 2E can replace the two-dimensional turning elements in the 2×N turning element array 10″ of FIG. 4C that underlies the 1×N optical source or VCEL array chip 140 or 1×N photodetector array chip 150 of FIGS. 4B, 4C, or a combined VCSEL and PD array chip. In such embodiments, there are four (4) reflecting surfaces of the unitary pyramidal structure 15 that is located under one optical source/detector/chip integrated in a packaging substrate so that light from the optical source or light to the photodetector chip can go to or be received from more than one direction, e.g., from/to more than one other chips on a substrate either unidirectionally (outgoing), unidirectionally (incoming) or bidirectionally.

That is, taking the VCEL array 140 of 1×N VCSELs shown in FIG. 4A, FIG. 5A shows a cross-sectional view of the overlay of an optical emission area or optical emission portion 142 of the VCSEL array element 142 taken along line A-A′ shown in FIG. 4A over a light turning element block 19 showing a single top collimating/focusing lens 20G. In a non-limiting embodiment, VCSEL array 140 consists of multiple VCSEL element unit blocks 142 depicted in an in-line or linear arrangement, e.g., along a single row. As shown in FIG. 5A, each of these VCSEL element light turning blocks 142 that are organized into a VCSEL array 140 consist of an optical signal source, e.g., VCSEL/optical element 146, provided at a VCSEL array unit block 142 located at an optical emission area 152. In the VCSEL array unit block 142, the optical element 146 provides optical signals 145 of a light signal intensity 175 sufficient to span each of the four (4) TIR surfaces or mirrors 17E, . . . , 17H shown on respective side edges 15E, . . . 15H of a pyramidal portion 15 as shown in a top-down view of light turning pyramidal portion 15 of FIG. 5A for re-directing received optical signals from the single lens 20G. In embodiments, this distance may span 10 microns to 100 microns, e.g., after collimating by a focusing lens. That is, at the inner surfaces of the block 19 at a removed portion providing inner side edges or facets 15E, 15F, 15G, 15H in the turning element block 19. Connecting a VCSEL light emitting source at optical emission area 152 is a pair of optical element electrical pads 154 for receiving signals used to actuate the VCSEL light source at VCSEL Array 140 to provide light signals for input to the light turning element block 19 shown disposed underneath with a single collimating/focusing lens in direct alignment. The VCSEL Array unit block 142 further includes an optical signal path 148 at the VCSEL element 146 for focusing optic signals into a single collimating/focusing lens 141 shown in an aligned orientation at a bottom surface of the VCSEL Array unit block 142. The collimating/focusing lens 141 focusses optical signals 145 of an intensity 175 into the aligned top collimating/focusing lens 20G at the top surface of turning element block 19 shown in FIG. 5A. Thus, FIG. 4A additionally conceptually depicts two adjacent VCSEL Array unit blocks 142 of VCSEL Array 140 in a in-line arrangement with each respective adjacent VCSEL element 146 sourcing light or optic signals into a respective light turning block 19 that reflects them as optical signals 177 that emanate from each of four side edges of light turning block 19 for transmission in respective waveguides (not shown) outside of linear turning block 19.

Likewise, the embodiment of the underlying lens array 10″′ depicted in FIG. 4C can include an arrangement, e.g., 2×2 array, of light turning element blocks 19 with light turning pyramidal portions having four (4) turning mirrors or inner reflecting surfaces 17E, 17F, 17G, 17H as shown in FIG. 5A. That is, FIG. 5A shows a cross-sectional view of the further disposed light turning element 19 taken along line B-B′ that can substitute for element 14′ in the embodiment shown in the underlying lens array 10′″ of FIG. 4C showing a staggered arrangement of internal light reflective surfaces or TIR mirrors 17E, . . . 17H. While there is a 2×2 array of mirrors shown, the array 10′″ of FIG. 4C can be an M×N array of mirrors. Thus, the embodiment of FIG. 4C includes an arrangement of the reflecting surfaces or TIR mirrors 17E, 17F, 17G, 17H in light turning element blocks 19 provided for one row underlying the array 140 such that the reception of optical signals generated from a respective overlying VCSEL (not shown) at top most lenses that are reflected by TIR mirrors or reflecting surfaces 17E, 17F, 17G, 17H for transmission or conveyance through turning element block 19 as optic signals 177 as shown in FIG. 5A through laterally extending optical signal path 16E, 16F, 16G, 16H.

Thus, in the view of FIG. 4A, a similarly structured photodetector array 150 depicted as a 2×N array of staggered photodiode or like photodetector device elements 162 can be in alignment with a respective arrangement of the collimating/focusing lens on top of the light turning element, e.g., light turning element block 19 of FIG. 2E. In a non-limiting embodiment, as shown in FIG. 5A, the photodetector device elements 162 is structured similarly to the VCSEL element unit blocks 142, however, instead include a photodetector element 156 to receive optical signals transmitted through the light turning element block. A photodetector element 156 can be a photodiode or like light receiving device. As in the VCSEL array 140, photodetector array 150 of FIG. 4A include photodetector element unit blocks 162 depicted in the staggered linear arrangement along one or more rows. As further shown in FIG. 4B, each of these photodetector element unit blocks 162 organized into a photodetector array 150 consist of a single optical signal sensor, e.g., photodetector element 156, provided at a photodetector array unit block 162 located at a single optical emission area 152. In each photodetector array unit block 162, the photodetector element 156 is dimensioned to receive optical signals in a span of a distance corresponds to a distance separating the TIR surfaces or mirrors 17E, 17F, 17G, 17H shown in the turning element block 19. In embodiments, this distance may span 10 microns to 100 microns, e.g., after collimating by a focusing lens. Connecting each respective photodetector 156 at an optical emission area 152 is a pair of optical element electrical pads 154 for receiving signals used to actuate the photodetector at photodetector array 150 to receive light signals from the light turning element block 19 shown disposed underneath with a single collimating/focusing lens in direct alignment. The photodetector array unit block 162 further includes a single optical waveguide structure 148 corresponding to the photodetector element 156 for receiving optic signals from a respective collimating/focusing lens 141 shown in an aligned orientation at a bottom surface of the photodetector array unit block 162. The collimating/focusing lens 141 focusses received optical signals 175 from the aligned top collimating/focusing lens 20G at the top surface of turning element block 19 shown in FIG. 5A. FIG. 4A conceptually depicts two adjacent photodetector array unit blocks 162 of photodetector array 50 with each photodetector element 156 receiving light or optic signals from waveguides (not shown) outside of linear light turning block 19 that reflects the optical signals for detection at a respective photodetector element 156. FIG. 5B shows a top view of an staggered or angled arrangement 190 of “M” light turning element blocks 19 that can be part of a lens array 10″ such as depicted in FIG. 4C, that can be an M×N array arrangement of light turning element blocks 19, each with a pyramidal portion 15 having four (4) turning mirrors or inner reflecting surfaces 17E, 17F, 17G, 17H such as shown in FIG. 5A. Each light turning element block 19 having a pyramidal portion 15 with four (4) edges providing TIR mirrors or like reflective surfaces can each receive/reflect both unidirectional (outgoing or ingoing) and bidirectional light or optic signals 177 for non-crossing transmission in four directions. Iin FIG. 5A, for example, in a given “Z”-plane, there can be oriented and arrangement of staggered light turning elements in “X” and “Y” dimensions. It should be understood that, in alternate embodiments, the mirrors 17E-17H and similarly mirrors 17A-17D (in turning light blocks of FIGS. 2A-2B) can be dichroic mirrors, i.e., the mirror reflectors can be reflecting for some wavelengths and allow transmission for other wavelengths. The use of dichroic mirrors in the alternate embodiments permits wavelength division multiplexing (WDM), or coarse WDM (CWDM) when using multimode VCSELs.

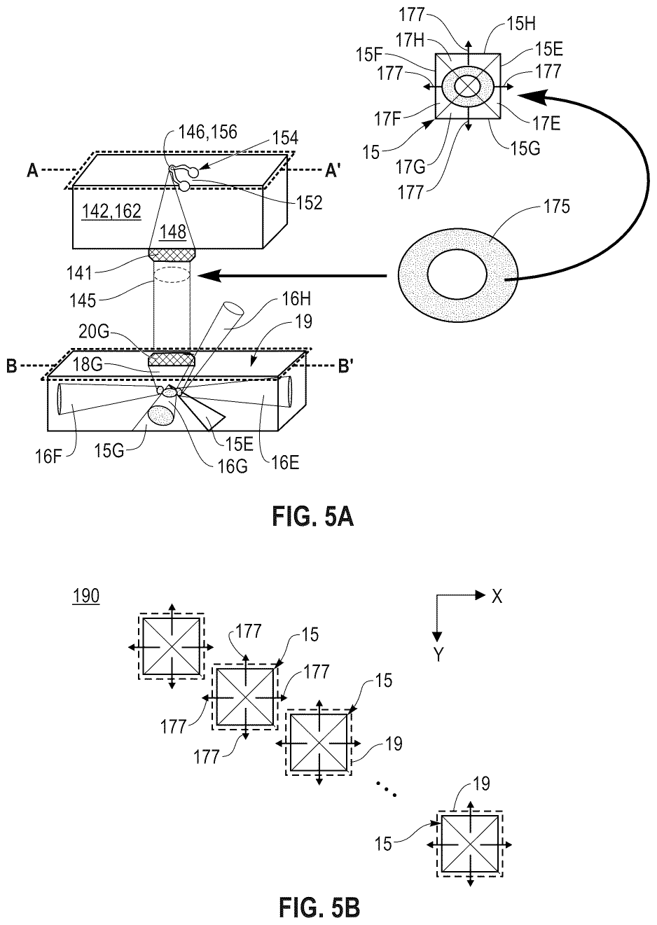

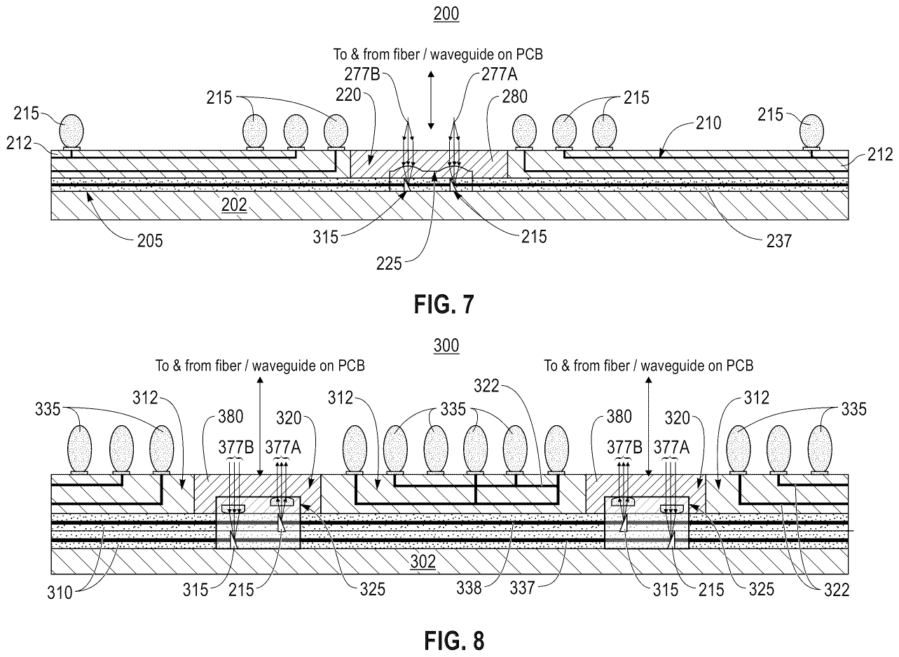

FIG. 6A depicts a top down view of a single integrated optical transparent lens array chip 180 including a 2×M array of light element turning blocks 19, each with a pyramidal portion 15 having four (4) turning mirrors or inner reflecting surfaces 17E, 17F, 17G, 17H providing reflected optical signals 177 in four directions such as shown in FIG. 5A. This arrangement forms two optical signal direction height dimensions, i.e. accommodating two layer optical PCB (as in FIG. 8) and in side views of FIGS. 6B-6C.

FIG. 6B is a sideview of the lens array chip 180 structure taken along line D-D′ of FIG. 6A. The side view of FIG. 6B, shows a horizontally oriented three-dimensional single integrated optical transparent lens array chip composed of an L x M array of light element turning blocks 19. In view of the side view of FIG. 6B, “L” is the “Z”, or height dimension (two-layer) 182, and “M” is the “X” and “Y” (or in-plane) optical signal directing dimension 185. In FIG. 6B, chip 180 includes an array of first light turning blocks 19A is shown at a first layer providing the pyramidal portion 15 having the turning mirror reflecting surface for reflecting optical signals 177 horizontal at a first height or level, and an adjacent array of second light turning blocks 19B is shown at a second layer, elevated with respect to the first layer, providing the pyramidal portion 15 having the turning mirror reflecting surface for reflecting optical signals 177 horizontally at a second height or level.

Similarly, FIG. 6C is a sideview of the lens array chip 180 structure taken along line C-C′ of FIG. 6A. The side view of FIG. 6C, shows a vertically oriented three-dimensional single integrated optical transparent lens array chip composed of an L×M array of light element turning blocks 19. In view of the side view of FIG. 6C, “L” is the “Z”, or height dimension (two-layer) 182, and “M” is the “X” and “Y” (or in-plane) optical signal directing dimension 185. In FIG. 6C, chip 180 includes an array of first light turning blocks 19C as shown at a first height providing the pyramidal portion 15 having the turning mirror reflecting surface for reflecting optical signals 177 vertically and perpendicular to a first in-plane location, and an adjacent array of second light turning blocks 19D is shown elevated with respect to the location of the first light turning block 19C, providing the pyramidal portion 15 having the turning mirror reflecting surface for reflecting optical signals 177 vertically and perpendicular to a second in-plane location.

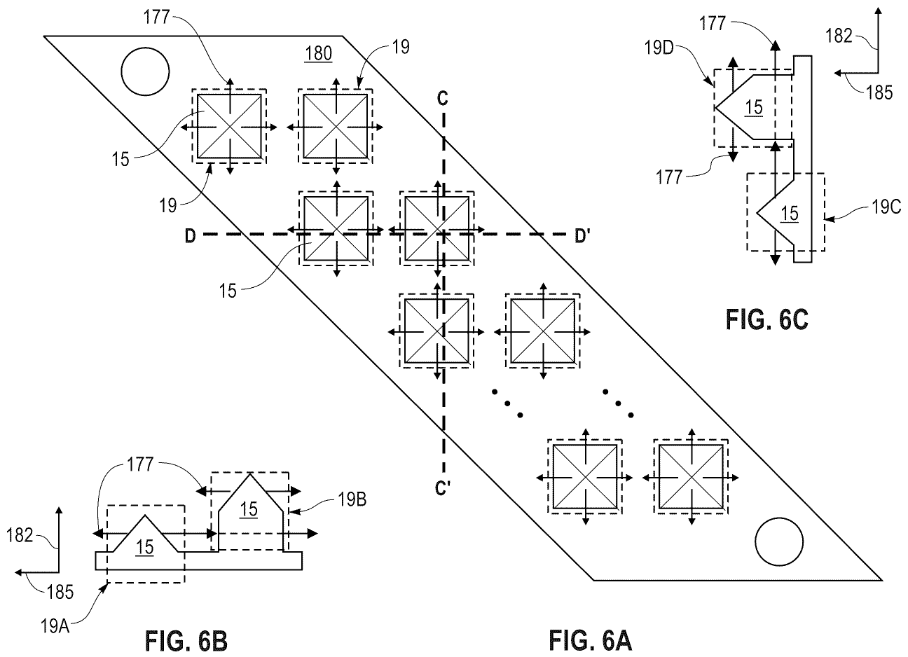

FIG. 7 depicts a cross-sectional view of a single layer optical printed circuit board (PCB) 200 providing waveguide routing enabled with optical lens focusing mirror array element according to embodiments herein. As shown in FIG. 7, the PCB 200 is an optical PCB including a substrate 202 having a clad-core-clad single layer horizontally disposed waveguide 205 embedded therein that can carry optical signals. Additionally included in a top layer structure 212 above horizontally disposed waveguide layer 205 are one or more electrical interconnect layers 210 within which are embedded electrical wires for carrying electrical signals and that connect to interconnect structures 215 such as ball-grid-array (BGA)/land grid array (LGA) interconnects 215 disposed above top layers 210. As shown, the top layer structures 210 include a defined space or opening 220 within which can be situated one or more light turning elements, such as light element turning block 12 (of FIG. 2A), light element turning block 13 (of FIG. 2B), light element turning block 14 (of FIG. 2C), light element turning block 14′ (of FIG. 2D), or light element turning block 19 (of FIG. 2E). As an example, within the space 220 can be located a lens array chip 225 having one or more turning lens blocks, e.g., a light element turning block(s) 12 (of FIG. 2A), light element turning block(s) 13 (of FIG. 2B), light element turning block(s) 14 (of FIG. 2C), light element turning block(s) 14′ (of FIG. 2D), or light element turning block(s) 19 (of FIG. 2E). In the example depicted in FIG. 7, a lens array chip 225 can include a light turning block providing a first pyramidal-shaped light turning element 215 and a second pyramidal light turning element 315. In such an embodiment, for example, integrated optical transparent lens array chip 225 having a first triangular or pyramidal light turning element 215 and waveguide (not shown) can receive incoming light signals 237 via a coupled, e.g., abutting, PCB optical waveguide 205 or PCB optical fiber and re-direct light 277A for transmission upwards above the chip through an aligned collimating lens (not shown) in a direction normal to its arrival.

Similarly, for example, integrated optical transparent lens array chip 225 can have a second triangular or pyramidal light turning element 315 and waveguide (not shown) that can receive incoming light 277B through an aligned collimating lens (not shown) from above the chip 225 and re-direct as light signals 237 in a direction normal to its arrival for transmission via PCB optical fiber or waveguide 205. As further shown in FIG. 7, a transparent filler material 280 can dispensed within the opening 220 to cover and protect lens array chip 225. It is also understood that the integrated optical transparent lens array chip 225 has the appropriate lensing effect for light when its dielectric constant is greater than that of the transparent filler material 280.

FIG. 8 depicts a cross-sectional view of a two-layer optical-PCB 300 showing waveguide routing scaling for enabling node-to-node higher dimension architecture enabled with optical focusing lens turning mirror array element according to embodiments herein. As shown in FIG. 8, optical-PCB 300 includes a substrate 302 having a clad-core-clad horizontally disposed double layer waveguide 310 embedded therein that can carry optical signals along horizontally disposed waveguide and/or optical fibers. Additionally included in a top layer structure 312 above horizontally disposed double waveguide layer 310 are one or more electrical interconnect layers 312 within which are embedded electrical wires 322 for carrying electrical signals and that connect to interconnect structures 335 such as ball-grid-array (BGA)/land grid array (LGA) interconnects 335 disposed above top layer structure 312. As shown, the top layer structures 312 include one or more defined spaces or openings 320 within which can be situated one or more light turning elements, such as light element turning block 12 (of FIG. 2A), light element turning block 13 (of FIG. 2B), light element turning block 14 (of FIG. 2C), light element turning block 14′ (of FIG. 2D), or light element turning block 19 (of FIG. 2E). As an example, within the space 320 can be located a lens array chip 325 having one or more turning lens blocks, e.g., a light element turning block(s) 12 (of FIG. 2A), light element turning block(s) 13 (of FIG. 2B), light element turning block(s) 14 (of FIG. 2C), light element turning block(s) 14′ (of FIG. 2D), or light element turning block(s) 19 (of FIG. 2E). In the example depicted in FIG. 8, within each space 320 can be located a lens array chip 325 including integrated optical transparent lenses with light turning block elements, e.g., providing a first pyramidal-shaped light turning element 215 and a second pyramidal light turning element 315. In such an embodiment, for example, integrated optical transparent lens array chip 325 having a first triangular or pyramidal light turning element 215 and waveguide (not shown) can receive incoming light signals 337 via a coupled, e.g., abutting, PCB optical waveguide layer(s) 310 or PCB optical fiber and re-direct light 377A for transmission upwards above the chip (or downwards) through an aligned collimating lens (not shown) in a direction normal to its arrival. Similarly, for example, integrated optical transparent lens array chip 325 can have a second triangular or pyramidal light turning element 315 and waveguide (not shown) that can receive incoming light 377B through an aligned collimating lens (not shown) from above the chip 325 and re-direct as light signals 338 in a direction normal to its arrival for transmission via a coupled, e.g., abutting, PCB optical fiber or waveguide layer(s) 310. An example of a 3-dimensional single integrated optical transparent lens array chip 325 is shown in FIG. 6B. As further shown in FIG. 8, a transparent filler material 380 such as encapsulant (epoxy resin), underfill material (polyimides, silicones), a dielectric, or plastic/polymer material can dispensed within the opening 320 to cover and protect lens array chip 325. It is also understood that the integrated optical transparent lens array chip 325 has the appropriate lensing effect for light when its dielectric constant is greater than that of the transparent filler material 380.

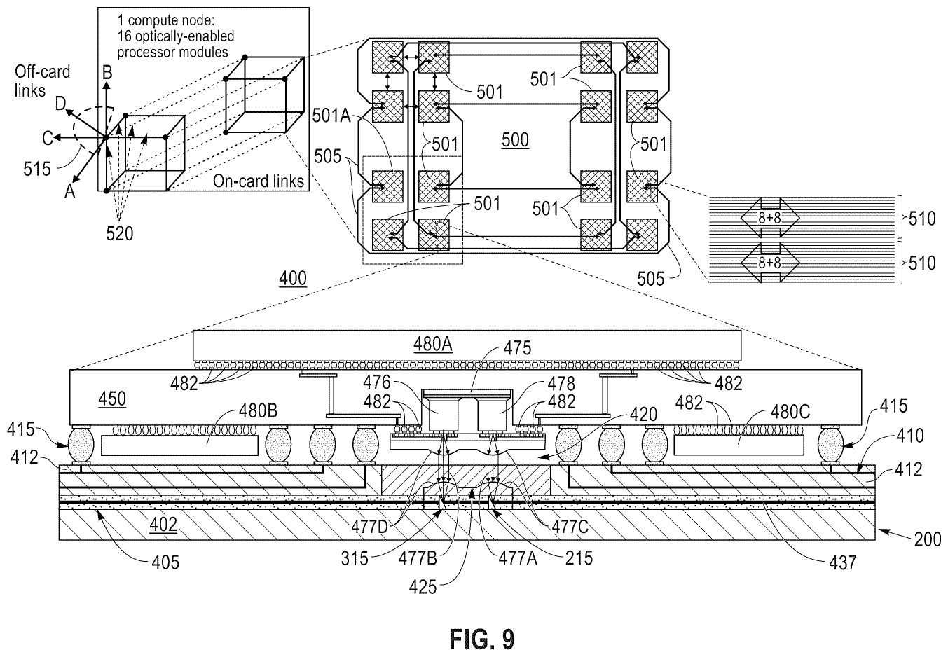

FIG. 9 depicts a cross-sectional view of an assembly 400 including an optical PCB structure 200 for use in a higher bandwidth (BW) on-board node-to-node architecture using the focusing lens turning mirror array according to embodiments herein. In FIG. 9, the assembly 400 includes the single layer optical printed circuit board (PCB) 200 such as shown in FIG. 7, providing waveguide routing enabled with optical lens focusing mirror array element according to embodiments herein. The optical PCB 200 includes a substrate 402 having one (or more) clad-core-clad single layer horizontally disposed waveguide(s) 405 embedded therein that can carry optical signals. Additionally included in a top layer structure 412 above horizontally disposed waveguide layer 405 are one or more electrical interconnect layers within which are embedded electrical wires 410 for carrying electrical signals and that connect to interconnect structures 415 such as BGA/LGA interconnects 415 disposed above top layers 412. As shown, the top layer structures 412 include a defined space or opening 420 within which can be situated one or more light turning elements, such as light element turning block 12 (of FIG. 2A), light element turning block 13 (of FIG. 2B), light element turning block 14 (of FIG. 2C), light element turning block 14′ (of FIG. 2D), or light element turning block 19 (of FIG. 2E) providing up to four light turning directions. As an example, within the space 220 can be located a lens array chip 425 having one or more turning lens blocks, e.g., a light element turning block(s) 12 (of FIG. 2A), light element turning block(s) 13 (of FIG. 2B), light element turning block(s) 14 (of FIG. 2C), light element turning block(s) 14′ (of FIG. 2D), or light element turning block(s) 19 (of FIG. 2E). In the example depicted in FIG. 9, a lens array chip 425 can include a light turning block providing a first pyramidal-shaped light turning element 215 and a second pyramidal light turning element 315. In such an embodiment, for example, integrated optical transparent lens array chip 425 having a first triangular or pyramidal light turning element 215 and abutting waveguide (not shown) can receive incoming light signals 437 via a coupled, e.g., abutting, PCB optical waveguide 405 or PCB optical fiber and re-direct light or optic signals 477A for transmission upwards above the chip through an aligned dual collimating lens 477C in a direction normal to its arrival. Similarly, for example, integrated optical transparent lens array chip 425 can have a second triangular or pyramidal light turning element 315 and abutting waveguide (not shown) that can receive incoming light or optic signals 477B through an aligned dual collimating lens 477D from above the lens array chip 425 and re-direct as light signals 437 in a direction normal to its arrival for transmission via PCB optical fiber or waveguide 405.

In the assembly 400 depicted in FIG. 9, the BGA or LGA interconnect elements 415 are electrically connected to and support an interposer or like carrier substrate 450 that includes a M×N VCSEL array (e.g., into the plane of the page) including optical sources such as VCSELs 476 for providing focused optical signals 477B via a respective dual collimating/focusing lens, and further includes a M×N PD array (e.g., into the plane of the page) including photodetectors such as photodiodes 478 for receiving focused optical signals 477A via a respective dual collimating/focusing lens. Any input optical signals 477A received at a respective photodiode 478 and/or any electric signals received via wires 410 and interconnects 415 can be forwarded to further electronic chip structures 480A, 480B, 480C, e.g., a buffers/memory, a microprocessor chip, a logic chip, active device chips, passive devices, e.g., capacitors, etc. via additional interconnect structures 482 connected to the interposer or carrier 450 for further processing. For clarity, electrical signals between chip structures are not shown on carrier 450. Likewise, output optical signals 477B provided from VCSEL 476 can be generated upon receipt of command/control signals e.g., received from wires 410 and interconnects 415, and/or command/control signals received from electronic chip structures 480A, 480B, 480C via additional interconnect structures 482 connected to the carrier 450.

Plural assemblies 400 of FIG. 9 can be configured as in a higher bandwidth node-to-node architecture 500 that includes nodes 500, e.g., each node having 16 optically-enabled processor modules 501, with each node consisting of the assembly 400 depicted in FIG. 9. For example, an exemplary node optically-enabled processor module 501A (constituting the assembly 400) can include both electrical and optical connections including, for example, a top processor chip, and two (2) electrical connections for connection to two (2) nearest neighbors and two (2) optical thru waveguide links 505. In an embodiment, the 2D optical connections on a PBC can be achieved in a single waveguide (WG) layer with no optical link crossings, e.g., providing a waveguide link of 8+8 channels, 12+12 channels, 16+16 channels, etc. For example, a processor module 501 can provide a single waveguide layer, and this WG layer providing two WG links of 8+8 bidirectional channels 510. As a further example, the plural assemblies 400 can be configured to form a 4-dimension torus architecture having multiple nodes with each node including 16 compute modules/cards 501. For example, each compute module 501 in a node 500 can consist of an assembly 400 having 8 links from each compute module including 4 optical “off-card” links 515 and 4 “on-card” electrical links 520 (i.e., 2 links thru waveguides (shown), fiber, etc.) and two electrical links. In the embodiment depicted, one node 500 includes 16 optically-enabled processor modules. In another configuration that incorporates two (double) waveguide layers as shown as layers 310 in FIG. 8, the two electrical links in 520 are replaced by two optical links (e.g., waveguide, fiber, etc.). These two optical links replacing the two electrical links 520 (that are alternately configured as including all optical links) are accommodated in the second layer of the two-layer optical-PCB 300 (FIG. 8). This provides an all optically-enable processor modules in node 500. It is understood that a further option to enable block 325 (FIG. 8) is to use a three dimensional array arrangement of light turning blocks 19 as shown in FIGS. 6A-6C.

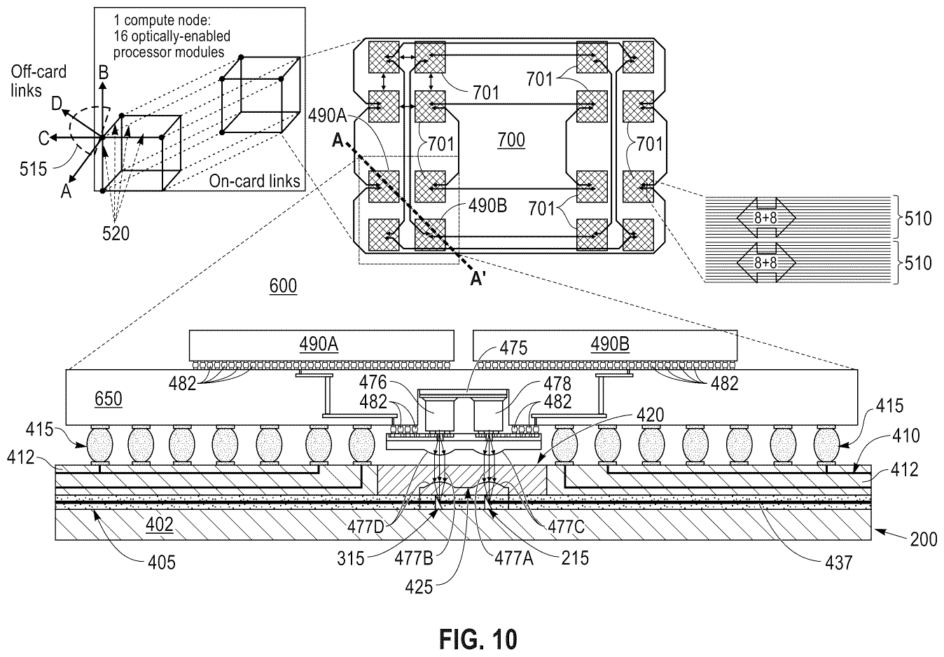

FIG. 10 depicts a further multi-node architecture 600 that forms a higher bandwidth node-to-node architecture enabled with non-crossing single layer optical interconnect elements integrated into the optical PCB 200. The assembly 600 of FIG. 10 substantially corresponds to the higher bandwidth node-to-node architecture 400 depicted in FIG. 9, however, the BGA/LGA interconnect elements 415 are electrically connected to and support a first level package/interposer or like carrier substrate 650 where, for clarity, other processor support chips (i.e., memory, etc.) and support components (i.e., decoupling capacitors, etc.) are not shown on the 1^{st} level package. Further, in the embodiment of the cross-sectional view of the optical PCB 200 shown in the architecture 600 of FIG. 10, rather than a single processor chip, there is configured a connection of two top-lying chips 490A, 490B, e.g., processors, on the single interposer structure 650 as shown in the cross-sectional view taken along line A-A′ in FIG. 10.

The architecture 600 depicted in FIG. 10 can further be configured as an inter-connected multi-node architecture such as a 4-D torus architecture 700 having multiple (e.g., sixteen) optically-enabled processor modules 701. This 4-D torus architecture can include a single interposer structure 650 having a cluster of processors, including processors 490A, 490B as shown taken along line A-A′ in FIG. 10 and includes electronic links and optical bidirectional channels 510 such as provided in a single WG layer with no link crossings.

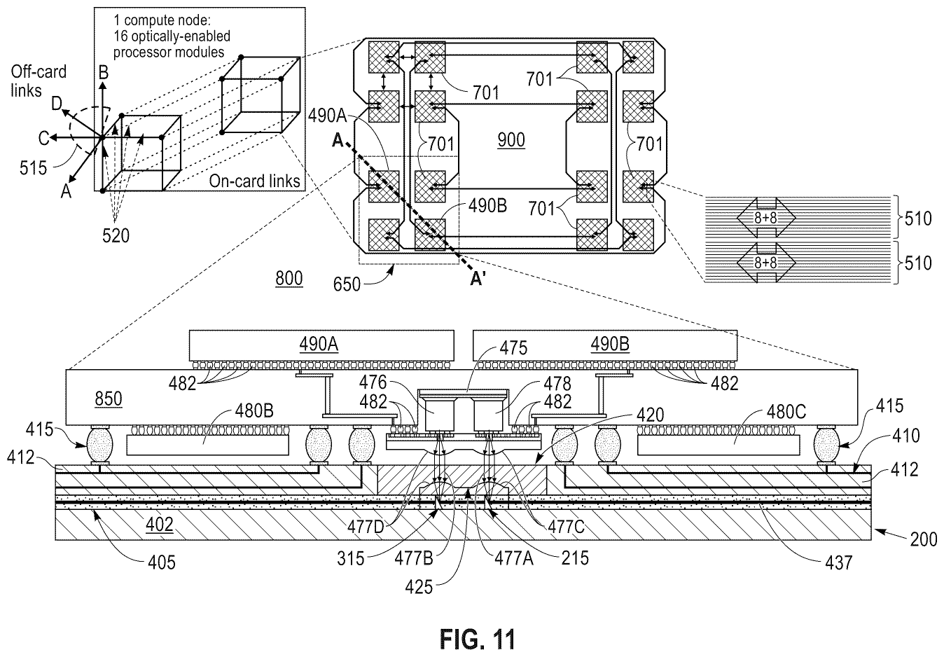

FIG. 11 depicts a further multi-node architecture 800 that forms a higher bandwidth node-to-node architecture enabled with a lens array chip 425 integrated into the optical PCB 200. The assembly 800 of FIG. 11 substantially corresponds to the higher bandwidth node-to-node architecture 600 depicted in FIG. 10, however, the BGA/LGA interconnect elements 415 are electrically connected to and support a first level package/interposer or like carrier substrate 850 carrying both two top-lying processor chips 490A, 490B, and further support at an underlying surface additional chip elements 480B, 480C e.g., active devices, passive devices, logic, memory, etc. on the single interposer structure 850. The architecture 800 depicted in FIG. 11 can further be configured as an inter-connected multi-node architecture such as a 4-D torus architecture 900 with a single interposer structure 650 having a cluster of processors, such as processor 490A, 490B as in the embodiment depicted in FIG. 10 and including electronic links and optical bidirectional channels 510 such as provided in a single WG layer with no link crossings.

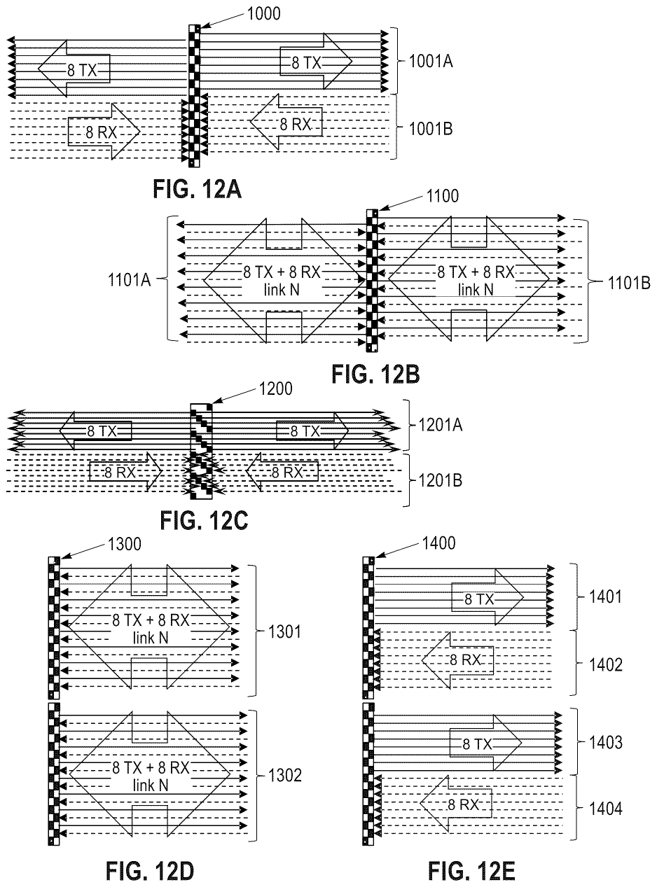

FIGS. 12A-12E depict various embodiments for routing optical signals in a high bandwidth on-board node-to-node architecture with focusing lens turning mirror array elements integrated into an optical PCB according to embodiments herein.

FIG. 12A is a depiction of an embodiment of a one-piece staggered bidirectional optical turning element array 1000 providing waveguide connections in the form of two 2×8 optical elements (OE) series arrays 1001A, 1001B with array 1001A including waveguide elements providing unidirectional outgoing (transmitting) optical connections (channels) and separate array 1001B including waveguide elements providing unidirectional incoming (receiving) optical connections (channels) according to the embodiments herein. Such a one-piece staggered bidirectional optical turning element array 1000 providing waveguide connections in the form of two 2×8 OE series arrays 1001A, 1001B can form the connections (channels) at a single compute node 501, 701 in the 4-D node-to-node torus architectures shown in the embodiments of FIGS. 9-11.

FIG. 12B is a depiction of another embodiment of a one-piece staggered bidirectional optical turning element array 1100 providing optical waveguide connections (channels) in the form of two 2×8 OE parallel arrays 1101A, 1101B with unidirectional outgoing (transmitting) optical connections (channels) of array 1101A interleaved with unidirectional incoming (receiving) optical connections 1101B according to an embodiment herein. Such a one-piece staggered bidirectional optical turning element array 1100 providing waveguide connections (channels) in the form of two 2×8 OE parallel arrays 1101A, 1101B can form the connections at a single compute node 501, 701 in the 4-D node-to-node torus architectures shown in the embodiments of FIGS. 9-11.

FIG. 12C depicts another embodiment of a staggered bidirectional optical turning element array 1200 providing optical waveguide connections (channels) in the form of two 4×4 OE series arrays 1201A, 1201B with array 1201A including waveguide elements providing unidirectional outgoing (transmitting) optical connections (channels) and separate array 1201B including waveguide elements providing unidirectional incoming (receiving) optical connections (channels) according to the embodiments herein. In the embodiments of FIG. 12C, the optical turning element array 1200 is configured with 3-dimensional focusing elements. Such a one-piece staggered bidirectional optical turning element array 1200 providing waveguide connections in the form of two 4×4 OE parallel arrays 1201A, 1201B can form the connections at a single compute node 501, 701 in the 4-D node-to-node torus architectures shown in the embodiments of FIGS. 9-11.

FIG. 12D depicts another embodiment of a one-piece staggered unidirectional optical turning element array 1300 providing optical waveguide connections (channels) in the form of four 1×8 OE series and parallel arrays. For example, there can be provided an array 1300 interfacing with communication links 1301 having eight unidirectional transmitting links and eight unidirectional receiving links interleaved as shown in FIG. 12D and further an array interfacing with communication links 1302 having eight unidirectional transmitting links and eight unidirectional receiving links interleaved as shown in FIG. 12D. In the embodiments of FIG. 12D, the optical turning element array 1300 is configured with 3-dimensional focusing elements. Such a one-piece staggered unidirectional optical turning element array 1300 providing waveguide connections in the form of four 1×8 OE series and parallel arrays 1301, 1302 can form the connections (channels) at a single compute node 501, 701 in the 4-D node-to-node torus architectures shown in the embodiments of FIGS. 9-11.

FIG. 12E depicts another embodiment of a one-piece staggered unidirectional optical turning element array 1400 providing optical waveguide connections (channels) in the form of four 1×8 OE series arrays. For example, there can be provided an array 1400 interfacing with a set of communication links 1401 having eight unidirectional transmitting links and a set of communication links 1402 having eight unidirectional receiving links as shown in FIG. 12E. Further, there can be provided interfacing with array 1400, a set of communication links 1403 having eight unidirectional transmitting links and a set of communication links 1404 having eight unidirectional receiving links as shown in FIG. 12E. In the embodiments of FIG. 12E, the optical turning element array 1400 is configured with 3-dimensional focusing elements. Such a one-piece staggered unidirectional optical turning element array 1400 providing waveguide connections in the form of four 1×8 OE communication links 1401, 1402, 1403, 1404 can form the connections at a single compute node 501, 701 in the 4-D node-to-node torus architectures shown in the embodiments of FIGS. 9-11.

Thus, aspects of the present invention provide a torus embedded hypercube architecture in the embodiments depicted in FIGS. 9-11 which is formed as a low loss, non-crossing optical node-to-node network on or in a printed circuit board.

The architecture includes structures configured to implement optical connectivity between out-of-plane to in-plane (e.g., using plural re-directing mirrors in a staggered configuration) that results in a system which can be implemented with small node degrees, implying a reduction in hardware cost per node. Also, a constant node degree results in a system that is scalable without having to modify the individual nodes. Further, by using optical interconnect connections as describe in the embodiments herein, the torus architecture provides a higher bandwidth, but also with cost effectiveness which is obtained by minimizing optical (fiber shuttle or waveguide) layers and connectors, and lower energy per bit by minimizing optical signal loss, such as through fewest optical connectors and a non-crossing (for waveguides) architecture.

The architecture arrays of microlenses with arrays of bi-directional (or even tri- or quad-directional) turning mirrors in a single element that can be inserted into optical PCBs, for example, polymer WG PCBs. This architecture includes a staggered lens arrays configuration with staggered mirror elements ideal for higher density polymer WG PCBs that are invaluable for AI or high-performance computing. Moreover, the same lens array/mirror element can be used either for uni-directional as well as bi-directional in-plane WG coupling.

In embodiments, the imbedded mirror array element is based on totally internal reflection (TIR) that does not need a reflective metal coating.

Further, there is provided an optical 2-D planar or staggered VCSEL/PD array output/input pattern formed onto a one-layer WG format, thus enabling higher density optical PCBs at lower cost (fewer layers), which results in reducing the number of parts and components, as well as the number of manufacturing processes and capable of mounting fewer parts and components at a higher density in an optical module, thereby realizing a lower cost.

The architectures described herein can be implemented as low cross-talk architectures such as Torus 2-D on a PCB entailing only one non-overlapping electrical interconnect layer and one non-overlapping optical WG interconnect layer, and thus at a lower cost and lower crosstalk that enable higher speed operation, thereby making it possible to implement lower cost and dense high-speed architectures, such as a complete 2-D Torus on an optical PCB using one electrical interconnect layer and one non-crossing WG layer due to higher precision alignment.

While the present application has been particularly shown and described with respect to various embodiments thereof, it will be understood by those skilled in the art that the foregoing and other changes in forms and details may be made without departing from the spirit and scope of the present application. It is therefore intended that the present application not be limited to the exact forms and details described and illustrated but fall within the scope of the appended claims.

What is claimed is:

1. An optical coupling element comprising:
a set of waveguide structures, each waveguide structure of said set receiving and channeling optical signals;
a set of internal light reflective surfaces, each internal light reflective surface associated with each waveguide structure,
one or more light focusing lenses disposed above said set of internal light reflective surfaces, each internal light reflective surface receiving optical signals through one of the one or more light focusing lens for re-directing to a waveguide structure, or receiving optical signals from a waveguide structure for re-directing through the one or more light focusing lens.

2. The optical coupling element as claimed in claim 1, further comprising:
an internal pyramidal structure having n sides, where n≥1, each side having an internal light reflective surface formed thereon, wherein said set of waveguide structures comprising n waveguide structures, each waveguide structure in alignment with a respective internal light reflective surface for channeling light to and from the respective internal light reflective surface.

3. The optical coupling element as claimed in claim 2, wherein each said waveguide structure of said set of waveguide structures receives optical signals communicated from a source aligned with said waveguide structure for re-directing the optical signals through a corresponding lens above said surface of said element via a corresponding internal light reflective surface.

4. The optical coupling element as claimed in claim 2, wherein each said light focusing lens of said one or more light focusing lenses receives optical signals communicated from an external source aligned with said lens above said element for re-directing the optical signals through a corresponding waveguide structure via a corresponding internal light reflective surface.

5. The optical coupling element as claimed in claim 2, comprising a single light focusing lens located at a surface of said optical element, each said n internal light reflective surface reflecting optical signals to said single lens.

6. The optical coupling element as claimed in claim 2, wherein said internal light reflective surfaces of said set are in a staggered orientation.

7. The optical coupling element as claimed in claim 2, wherein said internal light reflective surfaces are oriented adjacent one another in alignment.

8. The optical coupling element as claimed in claim 2, wherein said set of lens are located at a top surface of said element.

9. An optical communication system comprising:
an optical substrate;
an array of optical coupling elements formed on said optical substrate, each optical coupling element of said array comprising:
a set of waveguide structures, each waveguide structure of said set for receiving and channeling optical signals;
a set of internal light reflective surfaces, each internal light reflective surface associated with each waveguide structure,
one or more light focusing lenses disposed above said set of internal light reflective surfaces, each internal light reflective surface receiving optical signals through one of the one or more light focusing lens for re-directing to a waveguide structure, or receiving optical signals from a waveguide structure for re-directing through the one or more light focusing lens; and
an array of optical signal light signal generators disposed in alignment with said array of light turning elements formed on said optical substrate, each optical signal light generator sourcing an optical signal for receipt through a corresponding light focusing lens.

10. The optical communication system as claimed in claim 9, wherein said optical element further comprises:
an internal pyramidal structure having n sides, where n≥1, each side having an internal light reflective surface formed thereon, wherein said set of waveguide structures comprising n waveguide structures, each waveguide structure in alignment with a respective internal light reflective surface for channeling light to and from the respective internal light reflective surface.

11. The optical communication system as claimed in claim 10, wherein each said waveguide structure of said set of waveguide structures receives optical signals communicated from a source aligned with said waveguide structure for re-directing the optical signals through a corresponding lens above said surface of said element via a corresponding internal light reflective surface.

12. The optical communication system as claimed in claim 10, wherein each said light focusing lens of said one or more light focusing lenses receives optical signals communicated from an external source aligned with said lens above said element for re-directing the optical signals through a corresponding waveguide structure via a corresponding internal light reflective surface.

13. The optical communication system as claimed in claim 9, wherein said array of light turning elements formed on said optical substrate is a M×N array of light turning elements, the light turning elements oriented in a staggered configuration.

14. The optical communication system as claimed in claim 9, wherein said optical signal light signal generator is a vertical-cavity surface emitting laser.

15. An optical communication system comprising:
an optical substrate;
an array of light turning elements formed on said optical substrate, each light turning element of said array comprising:
a set of waveguide structures, each waveguide structure of said set for receiving and channeling optical signals;
a set of internal light reflective surfaces, each internal light reflective surface associated with each waveguide structure,
one or more light focusing lenses disposed above said set of internal light reflective surfaces, each internal light reflective surface receiving optical signals through one of the one or more light focusing lens for re-directing to a waveguide structure, or receiving optical signals from a waveguide structure for re-directing through the one or more light focusing lens; and
an array of optical signal light signal detectors disposed in alignment with said array of light turning elements formed on said optical substrate, each optical signal light detector sensing an optical signal received from a corresponding light focusing lens.

16. The optical communication system as claimed in claim 10, wherein said optical element further comprises:
an internal pyramidal structure having n sides, where n≥1, each side having an internal light reflective surface formed thereon, wherein said set of waveguide structures comprising n waveguide structures, each waveguide structure in alignment with a respective internal light reflective surface for channeling light to and from the respective internal light reflective surface.

17. The optical communication system as claimed in claim 16, wherein each said waveguide structure of said waveguide structures set receives optical signals communicated from a source aligned with said waveguide structure for re-directing the optical signals through a corresponding lens above said surface of said element via a corresponding internal light reflective surface.

18. The optical communication system as claimed in claim 16, wherein each said light focusing lens of said one or more light focusing lenses receives optical signals communicated from an external source aligned with said lens above said element for re-directing the optical signals through a corresponding waveguide structure via a corresponding internal light reflective surface.

19. The optical communication system as claimed in claim 15, wherein said array of light turning elements formed on said optical substrate is a M×N array, the light turning elements oriented in a staggered configuration.

20. The optical communication system as claimed in claim 15, wherein said optical signal light signal detector is a photodiode, phototransistor, light sensor or photodetector.
